(19) United States
(12) Patent Application Publication
(10) Pub. No.: US 2026/0275778 A1
(43) Pub. Date: Sep. 17, 2026

(54) Door Lock Actuating Device for Actuating a Door Lock of a Vehicle Door

(71) Applicant: Illinois Tool Works Inc., Glenview, IL (US)

(72) Inventors: Roland Och, Rottendorf (DE); Erik Dilje, Würzburg (DE); Matthias Hegwein, Ippesheim (DE)

(21) Appl. No.: 19/561,886

(22) Filed: Mar. 10, 2026

(30) Foreign Application Priority Data
Mar. 13, 2025 (DE) 10 2025 109 589.2

(51) Int. Cl. E05B 85/10; E05B 81/76

(52) U.S. Cl. CPC E05B 85/107; E05B 81/76

(57) ABSTRACT

A door lock actuation arrangement for a vehicle door, particularly for a flush door handle, includes an actuating element that moves from a flush rest position to an extended operating position through a linkage connected to a fixed support structure. A sensor is integrated directly into a movable part of the linkage, such as a lever arm. The sensor detects mechanical forces acting on the actuating element and distinguishes between pulling and pushing actions. A pulling force signals a request to open the door, while a pushing force indicates a locking request. The sensor may also detect the position of the actuating element through a defined mechanical bias in the rest position. Integrating the sensor in the linkage allows a single component to detect user intent, monitor handle position, and support safety functions such as pinch protection while reducing component count, packaging space, and system complexity.

### RELATED APPLICATION

The present application claims the benefit of German Patent Application No. 10 2025 109 589.2, filed Mar. 13, 2025, titled “Door Lock Actuating Device for Actuating a Door Lock of a Vehicle Door,” the contents of which are hereby incorporated by reference.

### BACKGROUND

Door handle assemblies are known for vehicles that serve to open and close doors or flaps. In the field of modern vehicle designs in particular, so-called flush or exactly flush door handles are increasingly used. These handles are flush integrated into the body or the door exterior in a rest position and are extended to an exposed, graspable position for operation.

Such arrangements, often referred to as “flush handles”, provide aesthetic, aerodynamic, and noise-related advantages. Movement of the handle element from the rest position to the operating position is typically externally actuated, for example by an electric motor.

In order to control the various functions of such a door handle, it is common to integrate a complex sensor technology. For example, proximity sensors are used to detect a user's request to extend the handle. Other sensors, such as capacitive sensors, touch sensors, or force sensors, are necessary to detect the request to unlock, lock, open, or retract the handle.

For example, the publication DE 197 31 325 A1 describes an actuating apparatus in which a handle part is displaceable to an opening position by means of external force.

DE 10 2024 119 554 A1 also discloses an actuating apparatus with a handle part which can be moved between a rest position and a standby position by an electromotive actuator.

The disadvantages of this known prior art are obvious. The need to integrate multiple different sensors for the different actuation requests results in significant complexity of the overall arrangement. This not only increases manufacturing and assembly costs, but also requires a considerable amount of design space within the vehicle door, which is often only available to a limited extent.

Moreover, the plurality of sensors results in a complex cable harness, which increases susceptibility to errors and increases the overall weight of the system. It is often not possible to accommodate all desired sensors in the door handle arrangement in a space-saving and cost-efficient manner.

### SUMMARY OF THE DISCLOSURE

The present disclosure relates generally to a door lock actuation assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a top plan view, an exemplary embodiment of the door lock actuation assembly according to the disclosure in a state in which the actuating element of the door lock actuation assembly is in its flush or retracted position (rest position).

FIG. 2 illustrates schematically and in a partially sectioned view, the door lock actuation assembly according to FIG. 1.

FIG. 3 illustrates schematically and in a top plan view, the exemplary embodiment of the door lock actuation assembly according to the disclosure, namely in a state in which the actuating element of the door lock actuation assembly is in its extended position (actuation position).

FIG. 4 illustrates schematically and in a partially sectioned view, the door lock actuation assembly according to FIG. 3.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a door lock actuation assembly for actuating a door lock of a vehicle door, particularly a vehicle outer door, as well as a corresponding method for operating, an evaluation device, a computer program product, and a vehicle having such an arrangement.

On the basis of this problem, the object of the disclosure is to provide a door lock actuation assembly that is as small in design dimensions as possible and reduced in complexity, and which can nonetheless reliably detect a plurality of different actuation requests of an operator.

The door lock actuation assembly according to the present disclosure comprises a manually actuatable actuation element, a support structure, and a mechanism that moves the actuation element between a flush position and an extended position.

The core of the disclosure is a sensor system with a single sensor, which is arranged in the mechanism and configured so that it can detect, in a differentiated manner, different types of force application exerted on the actuating element. By strategically integrating a single sensor into the movable mechanism of the door handle, different load cases, such as pulling, pushing, or static biasing, can be distinguished and interpreted as specific user requests. This replaces the need for multiple individual sensors.

The benefits of this solution are diverse. As required in the disclosure, the highest possible functionality is provided with the smallest possible number of sensors. This results in a dramatic reduction in the number of components, which in turn significantly reduces manufacturing costs and assembly complexity. The required design space in the door is minimized, which gives vehicle manufacturers more design freedom or allows for the integration of other components.

Furthermore, the cable harness is simplified, which not only saves costs but also increases overall system reliability, as potential sources of error are eliminated. Another, not insignificant benefit is weight reduction, which contributes to the overall efficiency of the vehicle.

The intelligent arrangement also allows additional functions such as an anti-pinch protection function to be implemented with the same sensor without the need for additional hardware.

The object is also achieved by a method of operating such an arrangement according to this disclosure.

This method protects the functional logic of the disclosure steps of sensing a type of force application by means of the sensor, generating a differentiated signal, determining a user request, and initiating the corresponding function.

Furthermore, the object is achieved by a vehicle comprising a door lock actuation assembly according to the present disclosure. For the vehicle manufacturer and the end user, advantages result from an aesthetically appealing, aerodynamic, and quiet door design that is at the same time more cost-efficient and reliable.

Finally, the problem is also solved by an evaluation device. This device is the “brain” of the system and is configured to receive the signals of the single sensor, distinguish between the different moments of force (tensile and compressive), and output corresponding control signals.

According to a preferred embodiment, it can be provided that the sensor is arranged in the mechanism, in particular integrated, and is configured such that the sensor can detect, in a differentiated manner, at least one tensile force exerted or exertable on the actuating element and one compressive force applied or applicable to the actuating element.

The ability to distinguish between a tensile force and a compressive force is the core of multifunctionality. This allows a clear and robust distinction between fundamentally different user intentions, such as “opening” (typically pulling) and “locking” or “retracting” (typically pushing). This clear differentiation dramatically reduces the misinterpretation rate of user actions, increasing the usability and safety of the system. The arrangement ensures that two of the most common interactions with a door handle are reliably detected by a single sensor.

According to a further embodiment, it may be provided that the sensor is arranged in the mechanism, in particular integrated, and configured so that, depending on the type of force application exerted or exertable on the actuating element, an individual sensor signal is or can be generated by the sensor.

Generating an individual, characteristic signal for each type of force application provides a significant advantage over simple binary sensing. Instead of merely recognizing that a force is being exerted, the system can now recognize how the force is being exerted (e.g., direction, intensity, duration). This opens up the possibility for a much more complex and nuanced control and enables the implementation of future functions without having to change the hardware. For example, a slight pull could trigger a different function than a strong pull.

In an alternative development, it can be provided that the sensor is arranged in the mechanism in such a way, in particular integrated, and configured to at least indirectly or qualitatively detect the magnitude of a moment of force exerted or exertable on the actuating element.

Sensing the magnitude of the moment of force in addition to its type (tensile/compressive) further increases the information density of the sensor signal. This allows a threshold-based logic in which a function is not triggered until a particular force is exceeded, preventing unintended actuation.

In addition, the strength of the user interaction may be used for control, for example for variable speed movement of the door handle. This feature makes the system smarter and more adaptable to different users and situations.

According to realizations of the disclosure, it is provided that the sensor is arranged in the mechanism, in particular integrated, and configured so that an individual sensor signal is generated or is generatable by the sensor depending on the magnitude of a moment of force exerted or exertable on the actuating element.

This configuration combines the advantages of the previous embodiments and allows for the generation of a signal whose characteristic (e.g., amplitude or frequency) directly correlates with the strength of the exerted force. This creates a very robust basis for signal processing, since not only can a distinction between tension and compression be made, but the respective intensity is also precisely detected. This is critical for functions such as anti-pinch protection, where the amount of resisting force must be directly converted into a control signal. It also enables fine-grained detection of user intentions.

According to a preferred embodiment, it can be provided that the sensor is arranged in the mechanism, in particular integrated into it, and is configured such that, when a force is applied to the actuating element, at least one position of the actuating element, in particular the flush, the extended, or an intermediate position, is detected by the sensor.

The ability of the sensor to detect not only forces but also the position of the actuating element is a significant advantage. As a result, the sensor may also function as one or more position sensors that would traditionally be required to monitor the state of the door handle (retracted, extended, etc.). This leads to a further reduction in the number of components and complexity. The system thus obtains a complete picture of the situation, not only knowing what the user wants, but also in which state the handle is.

In an alternative further development, it can be provided that the sensor system, in addition to the sensor integrated in the mechanism, comprises at least one further sensor that is configured to at least indirectly detect a position of the actuating element.

This configuration provides a redundant or supplementary position determination. While the mechanism-integrated force sensor assumes primary detection of user requests, a simpler, more cost-effective second sensor (e.g., a Hall sensor or a simple switch) may provide robust and independent position feedback. This increases the reliability of the overall system. For example, the second sensor may confirm the exact end position of the handle while the force sensor is responsible for dynamic interaction detection.

According to a further embodiment, the mechanism is associated with an actuator, in particular an electromotive actuator, which is operatively connected to the mechanism and/or to the actuating element such that the actuating element is transferable from its flush position to its extended position as needed and vice versa.

The connection of an actuator enables the externally operated movement of the door handle, which is a basic requirement for modern flush-fit handles. This allows the system to proactively respond to a detected user request (e.g., by a proximity sensor) and extend the handle. The combination of the actuator with the sensor technology according to the disclosure creates a complete, intelligent system that can both react to user proximity and detect subsequent manual actuation in a differentiated manner.

According to embodiments of the disclosure, it is provided that the further sensor is configured to determine the position of the actuating element at least indirectly on the basis of a position of an output of the actuator and/or on the basis of a number of revolutions performed with the output of the actuator.

Positioning via the actuator itself (e.g., via an encoder or by counting motor revolutions) is a particularly elegant and cost-efficient method. No separate sensor is needed on the handle mechanism; instead, information already present in the drive train is used.

This avoids additional wiring and components on the exposed grip mechanism and integrates position monitoring directly into the protected actuator unit, increasing robustness against environmental influences.

According to a preferred embodiment, the door lock actuation arrangement further comprises an evaluation device, which is configured to detect various actuation requests of an operator based on the sensor signals generated by the sensor and optionally based on sensor signals generated by a further sensor.

The evaluation device is the central intelligence of the system. It bundles the information from all sensors and translates it into specific actions. The benefit of a dedicated evaluation device is in the centralized processing, which simplifies software development and maintenance. It allows complex signal filtering and pattern recognition algorithms to be implemented to further increase the reliability of request detection.

In an alternative development, it can be provided that the evaluation device is further configured to generate and output a corresponding signal for initiating a component, in particular an actuator, as a function of a detected actuation request.

This direct coupling of request detection and actuator control makes the system responsive and autonomous. The evaluation device acts as a closed-loop system that detects a user action and immediately initiates the corresponding mechanical response (e.g., extension of the handle, actuation of the lock). This provides a seamless and intuitive user experience. The centralization of this logic in the evaluation device represents an efficient system architecture.

According to a further embodiment, the evaluation device is configured to learn corresponding actuation requests of the operator from sensor signals generated by the sensor at least in a learning phase.

Implementing a learning phase or machine learning is a significant advantage that makes the system adaptable and future-proof. The system can adapt to a user's individual habits (e.g., how much they typically pull on the handle) and thus improve detection accuracy over time. This reduces the need for elaborate and rigid factory calibration and allows the system to adapt to aging processes or slight mechanical changes, increasing long-term stability.

According to realizations of the disclosure, it is provided that the mechanism is configured to move the actuating element, preferably in a purely translational movement.

A purely translatory movement, in which the handle extends straight out of the door, is perceived by users as being particularly highly valuable and technically challenging. It avoids tilting movements that might be perceived as being less stable. Mechanically, this movement ensures that the forces exerted on the handle are introduced more evenly into the mechanism, which assists in precise sensing by the sensor and minimizes wear.

According to a preferred embodiment, the mechanism comprises a first and a second lever or hinge arm, each of which is hinged to the support structure on the one hand and to the actuating member on the other hand.

The use of two lever arms is a proven mechanical approach to ensure guided and stable movement of the actuating element. This double lever arrangement effectively distributes the loads and prevents the handle from tilting or wobbling, which is critical for longevity and haptic quality. It forms the structural basis for precise parallel or scissor kinematics.

In an alternative development, it may be contemplated that the first and second lever or hinge arms together form a parallelogram or scissor lever.

A parallelogram-shaped mechanism ensures that the actuating member performs a purely translational motion, which provides the above-mentioned advantages in terms of stability and high-quality appeal. Alternatively, a scissor lever mechanism provides a larger stroke with a more compact design. The definition of this specific kinematics protects the concrete mechanical solutions that allow for the stable and repeatable movement of the handle, which in turn is a prerequisite for the reliable function of the sensor.

According to a further embodiment, the sensor is configured to detect a corresponding force component introduced into the first and/or second lever or hinge arms or a relative position and/or orientation of the arms upon application of a force to the actuating element.

This design describes the core of the measuring principle: The sensor does not directly measure the force on the handle, but rather the resulting force component or position change within the supporting structure of the mechanism. This is a key advantage as the sensor can be placed in a protected position inside the mechanism, rather than exposed to the handle itself. This indirect measurement is robust against external influences and allows precise detection of the loads introduced into the system.

According to realizations of the disclosure, it is provided that the sensor is configured to detect compressions and/or extensions in a region of the lever or hinge arms or a relative movement between components of the mechanism upon application of a force to the actuating element.

The detection of stretching (extension) and compression in the lever arms is a direct method of distinguishing between tensile and compressive forces. A pull on the handle results in a stretching in the arms, a push in a compression. Alternatively, the relative movement may be detected. Both approaches provide a highly reliable physical basis for differentiating user intentions and making the system very robust against interference.

According to a preferred embodiment, the sensor is embodied as a piezoelectric force transducer, an electrodynamic force transducer, a capacitive force transducer, a resistive force transducer, and/or an optical sensor.

The list of different suitable sensor types provides a wide scope of protection and flexibility in technical implementation. Each sensor type has specific advantages: Piezo sensors are very dynamic and durable, resistive sensors (strain gauges) are precise and inexpensive, and optical sensors are non-contact and wear-free. By using these alternatives, it is prevented that the disclosure may be circumvented by the choice of a particular, not specified sensor type.

In an alternative refinement, it may be provided that the sensor is integrated in the first or the second lever or hinge arm.

Integrating the sensor directly into one of the supporting lever arms is the most elegant and space-saving solution. The lever arm then not only serves as a mechanical guide element, but simultaneously as a sensor housing and a force transmitter for the sensor. This significantly minimizes the number of individual parts and the assembly effort. It is the most direct and robust way to detect the loads within the mechanism.

According to another embodiment, the mechanism comprises a protrusion configured to apply a predetermined force to the support structure in the flush position of the actuating member, which is detected by the sensor as a signal for the flush position.

This protrusion creates a defined mechanical stop with a measurable bias in the rest position. This provides an invaluable advantage: The system receives positive, unambiguous feedback that the handle has safely reached its end position and is correctly locked. In contrast to a pure position measurement that is subject to tolerance, this force measurement confirms the fixed fit of the handle. The lack of this biasing signal would immediately indicate that the handle is not fully retracted, e.g., due to icing or an obstacle.

According to implementations of the disclosure, it is provided that the evaluation device is further configured to monitor a signal generated by the sensor during movement caused by the actuator and to detect an obstruction if the signal exceeds a predefined threshold in order to provide an anti-pinch protection function.

The use of the already existing force sensor for the anti-pinch function is a prime example of the efficiency of the disclosure. No additional hardware is needed to implement an important safety function. If the handle encounters an obstacle (e.g., a hand) during the retraction, the force measured by the sensor increases abruptly, whereupon the evaluation device can immediately stop or reverse the movement. This significantly increases the safety of the vehicle without causing additional costs or complexity.

Finally, according to one embodiment, the computer program product may comprise instructions that, when the program is executed by an evaluation device, cause it to perform the method according to the disclosure.

Protection as a computer program product secures the software that implements the inventive logic as a marketable asset. This extends protection to the pure software level and makes it difficult to circumvent patent protection through separate hardware and software supply chains.

Accordingly, it remains to be noted that the disclosure discloses a novel door lock actuation assembly, which is designed in particular for modern door handles that are flush with the vehicle body. The central idea of the disclosure is to replace the conventionally required plurality of sensors for various functions (e.g., extension, unlocking, locking) with a single, intelligently positioned sensor. This core of the disclosure allows for a significant reduction in complexity, cost, and required design space, which is of immense benefit, especially in the confined installation space of a vehicle door.

The mechanical basis for this multi-functional detection is a stable kinematics that move the actuating element serving as a door handle. Preferably, a parallelogram-shaped linkage consisting of two lever arms is used here, which ensures a purely translational and thus particularly high-quality movement of the handle out of and back into the vehicle body.

This precise and repeatable guide is a precondition for ensuring that the forces acting on the handle can be reliably introduced into the mechanism and measured therein. The robust construction ensures a long service life and a pleasant tactile appeal for the user.

The decisive inventive step lies in the strategic placement of the only sensor directly in one of the supporting lever arms of the mechanism. Instead of measuring the forces directly on the exposed door handle, the sensor, which is protected inside, detects the tensile and compressive forces that occur within the lever structure.

This allows the sensor to clearly distinguish between a tensile force (typical for the intent to open the door) and a compressive force (typical for the intent to lock the vehicle or retract the handle). A single sensor thus provides differentiated signals for at least two fundamentally different user intentions.

One particularly advantageous embodiment relates to the reliable detection of the end positions of the door handle, in particular the retracted rest position. Instead of using an additional position switch for this purpose, the disclosure utilizes a mechanical protrusion that applies a defined mechanical bias to the sensor-supporting lever arm in the rest position. The sensor measures this constant force and thus provides positive and unambiguous feedback that the handle has safely reached its end position.

This principle is more robust than conventional position sensors and can even detect problems such as an end position blocked by icing.

The differentiated signals provided by the sensor are interpreted by a downstream evaluation device, the “brain” of the system. This control unit is able to derive the clear intent of the user based on the signal characteristics (e.g., positive/negative amplitude for tension/compression, signal height for force strength) and initiate the corresponding actions, such as actuating the drive motor or the door lock. The continuous force measurement during the movement of the handle also allows a highly effective anti-pinch protection function to be implemented without additional hardware: A sudden increase in force signals an obstruction and the movement is stopped immediately.

In summary, the disclosure creates a highly efficient, cost-effective, and robust vehicle door handle actuation system that overcomes the drawbacks of the prior art by intelligently consolidating functions. The possibility to adapt the system through a learning phase to accommodate individual user habits underlines the future-oriented nature of the solution. The protection not only extends to the physical device itself, but also to the associated actuation method and the intelligent evaluation unit, which ensures comprehensive protection of the inventive concept.

The disclosure is described in further detail below with reference to the accompanying drawings. The drawings show an exemplary embodiment of the disclosure, but this is not to be understood as limiting. The components shown in the figures are not necessarily to scale; rather, emphasis is placed on clearly illustrating the inventive principles.

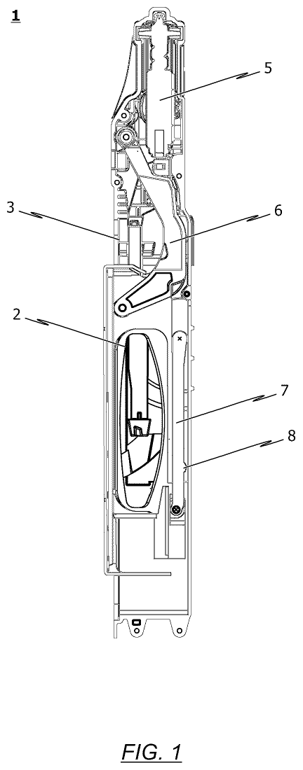

FIG. 1 shows a schematic top plan view of an exemplary embodiment of the door lock actuation assembly 1 according to the present disclosure. The arrangement is here in its flush or retracted position, which corresponds to a rest position.

In this state, the manually actuatable actuating element 2, which is configured as a door handle, is flush integrated into the vehicle body (not shown). The support structure 3 can be seen, which serves as a fixed base for the arrangement and is mounted on the vehicle door. The actuating element 2 is connected to the support structure 3 via a mechanism consisting of a first lever or hinge arm 6 and a second lever or hinge arm 7.

Also visible is the actuator 5 operatively connected to the first lever arm 6 to initiate movement of the actuating element 2. In this view, the protrusion 8 can also be seen, which performs an important function for position detection in the rest position.

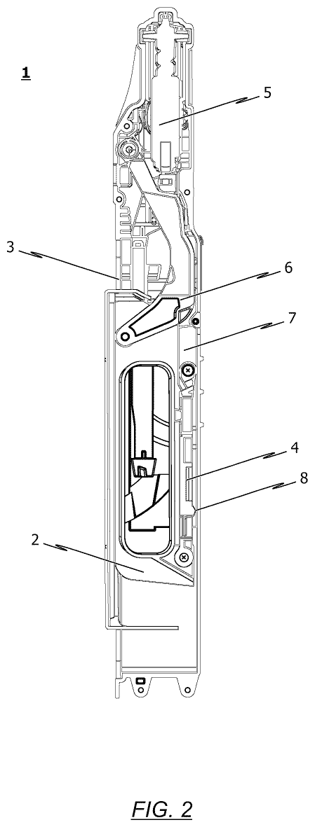

FIG. 2 shows a schematic and partially sectioned view of the door lock actuation assembly 1 according to FIG. 1, also in the rest position.

This cross-sectional view discloses the interior of the mechanism and illustrates the integration of the components. It can be clearly seen how the first lever arm 6 and the second lever arm 7 connect the actuating element 2 to the support structure 3 and thereby form a parallelogram-shaped kinematics.

Of particular importance is the integration, visible in this view, of the single sensor 4 directly into the structure of the second lever or hinge arm 7. This placement is critical for multi-functional sensing of forces and positions.

It can further be seen how the protrusion 8 in this retracted position abuts the support structure 3 and thereby applies a defined bias to the second lever arm 7 and thus to the sensor 4 integrated therein.

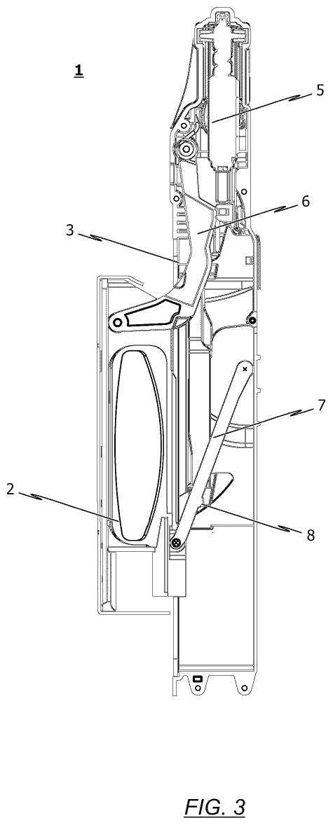

FIG. 3 shows a schematic top view of the door lock actuation assembly 1 in its extended position corresponding to an actuation position. The actuating element 2 now projects clearly out of the support structure 3 and is easily graspable by a user. This movement was triggered by the actuator 5 which pivoted the first lever arm 6, whereby the entire parallelogram-shaped mechanism moved the actuating element 2 purely translationally outwards. In this state, the protrusion 8 has lost contact with the support structure 3 and the bias measured in the resting state on the sensor 4 is no longer present.

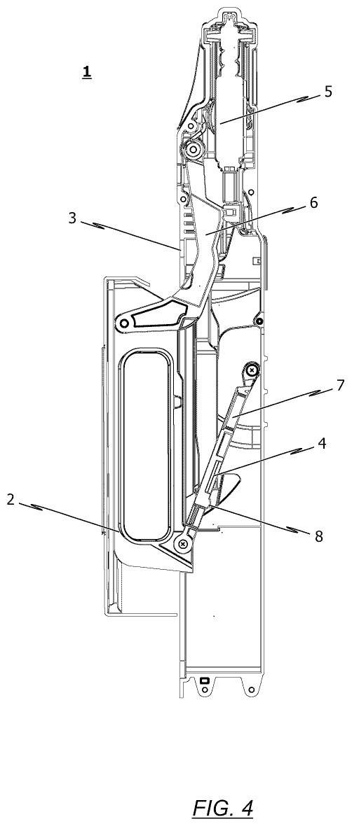

FIG. 4 shows a schematic and partially cut view of the door lock actuation assembly 1 according to FIG. 3 in the extended actuation position.

This view illustrates the position of the mechanical components in the extended state. It can be seen how the lever arms 6 and 7 are pivoted in order to guide the actuating element 2 outwards. The sensor 4 integrated in the second lever arm 7 is now in a neutral or unstressed starting position. Any manual force now exerted by the user on the actuating element 2, whether it is a pull to open the door or a push to lock, results in a direct tensile or compressive load in the second lever arm 7, which is precisely detected by the sensor 4 and passed as a differentiated signal to an evaluation unit.

The exemplary embodiment of the door lock actuation assembly 1 according to the disclosure, which is shown schematically and respectively in a top plan view (FIG. 1, FIG. 3) and in a partially sectioned view (FIG. 2, FIG. 4) in the accompanying drawings, serves to actuate a door lock of a vehicle door, also not shown here. For example, this vehicle door may be a vehicle exterior door.

The door lock actuation assembly 1 comprises a manually actuatable actuating element 2, which is in particular embodied in the form of a door handle or handle part. This actuating element 2 is provided to be manually grasped and actuated by a user, for example to open a door.

With the aid of a corresponding support structure 3, which can be fixed to a vehicle door, and a mechanism connected to the support structure 3 and associated with the actuating element 2, the actuating element 2 is mounted in a movable manner. It can be transitioned from a flush or retracted position shown in FIG. 1 and FIG. 2 to an extended position shown in FIG. 3 and FIG. 4 as needed.

The flush or retracted position of the actuating element 2 shown in FIG. 1 and FIG. 2 preferably depicts a rest position. In this rest position, the actuating element 2 is flush or retracted with respect to a door outer surface, resulting in a smooth, aerodynamically favorable vehicle surface. The extended position shown in FIG. 3 and FIG. 4, on the other hand, represents an actuating position. In this actuating position, the actuating element 2 projects relative to the door outer surface so that it can be easily grasped by a user.

In the exemplary embodiment shown in the drawings, the mechanism is configured such that the actuating element 2 is preferably moved in a purely translational motion from its flush position (FIGS. 1, 2) to its extended position (FIGS. 3, 4) and vice versa. The parallel movement necessary for moving the actuating element 2 is realized by two lever or hinge arms 6, 7.

The first lever or hinge arm 6 and the second lever or hinge arm 7 are each hinged to the support structure 3 on the one hand and to the actuating element 2 on the other hand. Together, the first lever arm 6 and the second lever arm 7 form a parallelogram with the support structure 3 and the actuating element 2.

One of the two lever or hinge arms, in the embodiment shown of the first lever arm 6, is operatively connected to an electromotive actuator 5. This actuator 5 can be used to move the actuating element 2 by means of an electric motor and external actuation from its rest position to its actuating position and vice versa.

As can be seen in particular from the sectional views in FIG. 2 and in FIG. 4, a single sensor 4 is provided. This sensor 4 is arranged in the mechanism, in particular integrated in the second lever or hinge arm 7, and is configured to detect different types of forces exerted on the actuating element 2 in a differentiated manner. This is preferably a piezo force transducer, although other types of sensors such as electrodynamic, capacitive, or resistive force transducers are contemplated.

By skillfully positioning and integrating the sensor 4 in the second lever arm 7, it is possible to distinguish between a tensile force exerted on the actuating element 2 (e.g., when attempting to open the door) and a compressive force (e.g., when pushing on the handle to lock). A pull on the actuating member 2 results in a tensile stress (extension) in the lever arm 7, while a pressure leads to a compressive stress (compression). These different loads are detected by the sensor 4 and converted into different electrical signals.

The sensor 4 is further configured to also detect the magnitude of the exerted force. Depending on the magnitude of the force, an individual sensor signal may be generated. This allows a distinction to be made between a light and a strong force and to accordingly trigger different functions or avoid unintended actuation.

Furthermore, the sensor 4 is able to detect a position of the actuating element 2. For this purpose, a protrusion 8 is configured on the second lever or hinge arm 7. In the flush or retracted position of the actuating element 2 (FIGS. 1 and 2), this protrusion 8 pushes against the support structure 3. A defined compression or bias is thereby generated in the second lever arm 7, which is detected by the sensor 4. This constant signal in the rest position serves as a clear indication that the handle is fully and correctly retracted.

The exemplary embodiment further comprises an evaluation device not shown herein. This is configured to receive the differentiated sensor signals generated by the single sensor 4 and to recognize different actuation requests by an operator as a result.

Using a tensile force signal, for example, the evaluation device detects the request to open, using a compressive force signal, the request to lock, and using the bias signal from the projection 8, the correct rest position. Depending on the detected request, the evaluation device can output corresponding signals, for example to drive the actuator 5 or the door lock.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Door lock actuation assembly
2 Actuating element (door handle)
3 Support structure
4 Sensor
5 Actuator
6 First lever or hinge arm
7 Second lever or hinge arm
8 Protrusion

What is claimed is:

1. A door lock actuation assembly (1) for actuating a door lock of a vehicle door, comprising:
a manually actuatable actuating element (2) in the form of a door handle;
a support structure (3), which is preferably fixed or fixable to a vehicle door and serves to support the actuating element (2);
a mechanism connected to the support structure (3) and associated with the actuating element (2) for transferring the actuating element (2) from a flush or retracted position as needed, which preferably represents a rest position, in which the actuating element (2) is flush or retracted with respect to a door outer surface, into an extended position, which preferably represents an actuation position, in which the actuating element (2) projects with respect to the door outer surface or projects to a greater extent than in the flush or retracted position; and
a sensor system with a sensor (4), which is arranged in the mechanism and is configured such that different types of force application exerted or exertable on the actuating element (2) are detected or are detectable by the sensor (4) in a differentiated manner.

2. The door lock actuation assembly (1) according to claim 1,
wherein the sensor (4) is arranged in the mechanism and is configured such that at least the following types of force actuation exerted or exertable on the actuating element (2) in a differentiated manner are detected or are detectable by the sensor (4):
a tensile force moment exerted or exertable on the actuating element (2); and
a compressive force moment exerted or exertable on the actuating element (2).

3. The door lock actuation assembly (1) according to claim 1,
wherein the sensor (4) is arranged in the mechanism and is configured such that an individual sensor signal is generated or is generatable by the sensor (4) depending on the type of force that is exerted or can be exerted on the actuating element (2).

4. The door lock actuation assembly (1) according to claim 1,
wherein the sensor (4) is arranged in the mechanism and is configured such that the sensor (4) at least indirectly or qualitatively detects the magnitude of a moment of force that is exerted or can be exerted on the actuating element (2).

5. The door lock actuation arrangement (1) according to claim 4, wherein the sensor (4) is arranged in the mechanism, and is configured such that an individual sensor signal is generated or can be generated by the sensor (4) depending on a magnitude of a moment of force that is exerted or can be exerted on the actuating element (2).

6. The door lock actuation assembly (1) according to claim 1,
wherein the sensor (4) is arranged in the mechanism and configured such that, in the event of an application of force to the actuating element (2), at least one position of the actuating element (2) is detected or is detectable by the sensor (4).

7. The door lock actuation assembly (1) according to claim 1,
wherein, in addition to the sensor (4) arranged in the mechanism, the sensor system comprises at least one further sensor, which is configured to detect at least indirectly at least one position of the actuating element (2).

8. The door lock actuation assembly (1) according to claim 1,
wherein an actuator (5) is associated with the mechanism and/or with the actuating element (2) in such a way that, as needed, the actuating element (2) is transferable from its flush or retracted position to its extended position with the aid of the actuator (5) and vice versa.

9. The door lock actuation assembly (1) according to claim 7, wherein the further sensor is configured to determine the position of the actuating element (2) based at least indirectly on a position of an output of the actuator (5) and/or on a number of revolutions performed by the output of the actuator (5).

10. The door lock actuation assembly (1) according to claim 1,
wherein the door lock actuation arrangement (1) further comprises an evaluation device, which is configured, based on the sensor signals generated by the sensor (4) and optionally based on sensor signals generated by a further sensor:
to recognize a request of an operator that, starting from the flush or retracted position of the actuating element (2), the actuating element (2) is to be transferred to its extended position; and/or
to recognize a request from an operator that, starting from the extended position of the actuating element (2), the actuating element (2) is to be transferred to its flush or retracted position; and/or
to recognize a request of an operator that, starting from the extended position of the actuating element (2), a door lock is to be locked; and/or
to recognize a request of an operator that, starting from the extended position of the actuating element (2), a door lock is to be unlocked.

11. The door lock actuation assembly (1) according to claim 10,
wherein the evaluation device is further configured, as a function of a detected actuation request of the operator, to generate and output a corresponding signal for initiating an actuator (5) that performs or is to perform the requested actuation.

12. The door lock actuation assembly (1) according to claim 10,
wherein the evaluation device is configured to learn corresponding actuation requests of the operator from sensor signals generated by the sensor (4) at least in a learning phase.

13. The door lock actuation assembly (1) according to claim 1,
wherein the mechanism is configured to transfer the actuating element (2), preferably in a purely translational movement or in a superposition of a translational and a rotational movement, from its flush or retracted position to its extended position and vice versa.

14. The door lock actuating assembly (1) according to claim 13, wherein the mechanism comprises a first lever or hinge arm (6), which is hinged on one side to the support structure (3) and on the other side to the actuating element (2), and a second lever or hinge arm

(7) which is hinged on one side to the support structure (3) and on the other side to the actuating element (2).

15. The door lock actuation assembly (1) according to claim 14,
wherein the first lever or hinge arm (6) of the mechanism and the second lever or hinge arm (7) of the mechanism together form a parallelogram; or wherein the first lever or hinge arm (6) of the mechanism and the second lever or hinge arm (7) of the mechanism together form a scissor lever.

16. The door lock actuation assembly (1) according to claim 14,
wherein the sensor (4) is configured, when exerting a force on the actuating element (2), to detect at least indirectly and preferably directly at least qualitatively a corresponding force component introduced into the first and/or second lever or hinge arm (6, 7); and/or wherein the sensor (4) is configured, when exerting a force on the actuating element (2), to detect at least indirectly and preferably directly at least qualitatively a position of the first and/or second lever or hinge arm (6, 7) relative to the support structure (3) and/or relative to the actuating element (2).

17. The door lock actuation assembly (1) according to claim 14,
wherein the sensor (4) is configured, when exerting a force on the actuating element (2), to detect at least qualitatively compressions and/or extensions at least in a region of the first or second lever or hinge arm (6, 7) of the mechanism; and/or wherein the sensor (4) is configured, when exerting a force on the actuating element (2), to detect a relative movement between at least one component of the mechanism and the support structure (3), the actuating element (2), and/or another component of the mechanism.

18. The door lock actuation assembly (1) according to claim 1,
wherein the sensor (4) is embodied as a piezo force transducer, as an electrodynamic force transducer, as a capacitive force transducer, as a resistive force transducer, and/or as an optical sensor (4).

19. The door lock actuation assembly (1) according to claim 14,
wherein the sensor (4) is integrated in the first lever or hinge arm (6) or in the second lever or hinge arm (7).

20. The door lock actuation assembly (1) according to claim 1,
wherein the mechanism comprises a protrusion (8) configured to apply a predetermined force to the support structure (3) in the flush or retracted position of the actuating element (2), wherein the predetermined force is detected by the sensor (4) as a signal indicative of the flush or retracted position.
